(19) United States
(12) Patent Application Publication
(10) Pub. No.: US 2023/0173542 A1
(43) Pub. Date: Jun. 8, 2023

(54) FASTENING OF SCREENING MEDIA TO SCREENING EQUIPMENT

(71) Applicant: SANDVIK SRP AB, Svedala (SE)

(72) Inventors: Adrien HENSSIEN, Svedala (SE); Andre FRIMAN, Svedala (SE)

(21) Appl. No.: 18/012,119

(22) PCT Filed: Jun. 24, 2020
(86) PCT No.: PCT/EP2020/067723

§ 371 Date: Dec. 21, 2022

(51) Int. Cl. B07B 1/46; F16B 13/00; F16B 13/12; F16B 21/04

(52) U.S. Cl. CPC B07B 1/4645; F16B 13/001; F16B 13/124; F16B 21/04; B07B 2201/02

(57) ABSTRACT

A sleeve and pin combination for fastening of one or more screening media elements to a corresponding attachment socket of a screening equipment, a screening media element for co-operation with the sleeve and pin combination, an arrangement for fastening of one or more screening media elements to corresponding attachment sockets of a screening equipment, and a method for fastening of one or more screening media elements to corresponding attachment sockets of a screening equipment and also a screening equipment for separating solid materials according to size is provided.

### FIELD OF INVENTION

The present disclosure relates generally to a sleeve and pin combination for fastening of one or more screening media elements to a corresponding attachment socket of a screening equipment, a screening media element for co-operation with the sleeve and pin combination, as well as an arrangement for fastening of one or more screening media elements to corresponding attachment sockets of a screening equipment and a method for fastening of one or more screening media elements to corresponding attachment sockets of a screening equipment and also a screening equipment for separating solid materials according to size.

### BACKGROUND ART

Equipment for mining and/or rock excavation, such as screening machines, often have limited space between screen decks, which makes it difficult to install screening media.

A thermoplastic pin and sleeve attachment system for installing screening media is well known and has existed on the market for a long time. Attachment of screening media using this well-known pin and sleeve fastening system usually require heavy sledgehammers for installation, which is done by forcing a pin into a sleeve such that it is expanded and attached to a corresponding attachment socket of an associated equipment. Removal of the same pin and sleeve components is often associated with the use of sledgehammers, screwdrivers, knifes and other similar tools.

EP 3 296 030 A1 disclose a pin and sleeve attachment system that enables fastening of lining elements to a support structure. It relies on the well-known type of sleeves in combination with a special type of threaded pin. The threaded pin is installed into the sleeves using a power tool, such as a screwing tool, by using a specially designed adapter tool, and thus eliminates the need to use a sledgehammer.

However, when using a threaded pin of the above type in conjunction with a standard sleeve the standard sleeve will sometimes tend to rotate with the pin when the pin is driven through the sleeve and when it is to be removed from the sleeve, making mounting and detachment problematic. Also, if rotation of the sleeve in relation to the screening media element occurs, heat build-up may occur in the thermoplastic pin and sleeve components, which may cause them to fail or break.

### SUMMARY OF THE INVENTION

An object of the present invention is to provide an improved sleeve and pin combination for fastening of one or more screening media elements to a corresponding attachment socket of a screening equipment.

According to a first aspect this is provided through a sleeve and pin combination for fastening of one or more screening media elements to a corresponding attachment socket of a screening equipment, said sleeve comprising an axially extending through opening and a first enlarged cross-section portion and a second reduced cross-section portion defining a radially outwardly extending sleeve stop ledge at a juncture therebetween where at least part of said second reduced cross-section portion of said sleeve is receivable in a said corresponding attachment socket, and wherein said pin is adapted to be inserted into said axially extending through opening of said sleeve and rotated to be secured therein to expand at least said second reduced cross-section portion thereof radially outwardly such that it, when received in a said corresponding attachment socket of a said screening equipment will become fastened by press fit thereto, and said sleeve further comprising one or more rotation prevention form elements adapted to interact with complementary rotation prevention form elements of said one or more screening media elements to prevent mutual rotation therebetween to become induced by a said rotation of said pin.

Thus, the above arrangement allows for safe and reliable installation and removal of screening media elements to and from corresponding attachment sockets of an associated screening equipment.

In a further embodiment of the sleeve and pin combination at least part of said second reduced cross-section portion of said sleeve comprises one or more axial slots, between said axially extending through opening and a periphery thereof, said one or more axial slots adapted to facilitate radial expansion of said second reduced cross-section portion of said sleeve by said pin.

In one alternative embodiment of the sleeve and pin combination said pin is threaded and adapted to be rotated upon insertion into said axially extending through opening of said sleeve such that it is screwed into said sleeve to become secured therein.

In another alternative embodiment of the sleeve and pin combination said pin comprises a first-half of a bayonet mount and said sleeve a second-half of a corresponding bayonet mount, and said pin is adapted to be rotated upon insertion into said axially extending through opening of said sleeve to become secured therein by interconnection of said bayonet mount halves resulting from a said rotation.

In some embodiments of the sleeve and pin combination said one or more rotation prevention form elements comprises at least one of radially extending cut-outs into or protrusions from a surface of at least one of said first enlarged cross-section portion and said second reduced cross-section portion.

In some further embodiments of the sleeve and pin combination said at least one of cut-outs into or protrusions from a surface of at least one of said first enlarged cross-section portion and said second reduced cross-section portion of said sleeve comprises at least one of: circle-sector shaped; spline shaped; or groove shaped, radially extending cut-outs or protrusions.

In yet further embodiments of the sleeve and pin combination said one or more rotation prevention form elements are provided through said first enlarged cross-section portion of said sleeve having an at least partially non-circular cross-section adapted to co-operate with an at least partially complementary shaped non-circular cross-section enlarged cross-section portion of a through opening or edge cut-out of a said screening media element.

According to a second aspect there is provided a screening media element for cooperation with the above sleeve and pin combination.

In a first embodiment said screening media element has one or more through openings or edge cut-outs each with an enlarged and a reduced cross-section portion defining a radially inwardly extending sleeve stop shoulder at a juncture therebetween, said one or more through openings or edge cut-outs being adapted to receive a respective said sleeve such that a said sleeve stop ledge thereof rest upon said sleeve stop shoulder and such that at least part of a said second reduced cross-section portion thereof protrudes from said screening media element such that it is receivable in a said corresponding attachment socket of a said screening equipment, wherein said screening media element comprises one or more rotation prevention form elements adapted to interact with complementary rotation prevention form elements of a said sleeve to prevent mutual rotation therebetween to become induced by rotation of a said pin upon insertion thereof into a said sleeve.

In a further embodiment of the screening media element said one or more rotation prevention form elements comprises at least one of radially extending cut-outs into or protrusions from at least one surface of said enlarged and said reduced cross-section portion of a respective of said one or more through openings or edge cut-outs.

In a still further embodiment of the screening media element said at least one of radially extending cut-outs into or protrusions from at least one surface of said enlarged and said reduced cross-section portion of a respective of said one or more through openings or edge cut-outs comprises at least one of: circle-sector shaped; spline shaped; or groove shaped, radially extending cut-outs or protrusions.

In one alternative embodiment of the screening media element said one or more rotation prevention form elements are provided through said enlarged cross-section portion of a said through opening or edge cut-out of a said screening media element at least partially having a non-circular cross-section adapted to co-operate with an at least partially complementary shaped non-circular cross-section of a said first enlarged cross-section portion of a said sleeve.

According to a third aspect there is provided an arrangement for fastening of one or more screening media elements to corresponding attachment sockets of a screening equipment.

In a first embodiment said arrangement for fastening of one or more screening media elements to corresponding attachment sockets of a screening equipment comprises: at least one screening media element having one or more through openings or edge cut-outs each with an enlarged and a reduced cross-section portion defining a radially inwardly extending sleeve stop shoulder at a juncture therebetween; at least one sleeve comprising an axially extending through opening and a first enlarged cross-section portion and a second reduced cross-section portion defining a radially outwardly extending sleeve stop ledge at a juncture therebetween; at least one pin adapted to be inserted into said axially extending through opening of said sleeve to expand at least said second reduced cross-section portion thereof radially outwardly; said one or more through openings or edge cut-outs of said at least one screening media element being adapted to receive a respective said sleeve such that a said sleeve stop ledge thereof rest upon said sleeve stop shoulder and such that at least part of said second reduced cross-section portion thereof protrudes from said screening media element such that it is receivable in a said corresponding attachment socket of a said screening equipment such that it, when thus received, is adapted to become fastened by press fit thereto upon a said radial outward expansion caused by insertion of a said pin, wherein each said at least one pin further is adapted to be rotated to be secured to a respective said sleeve upon insertion into a said axially extending through opening thereof, and said one or more through openings or edge cut-outs of said at least one screening media element and said sleeve comprises one or more complementary rotation prevention form elements adapted to, when said sleeve is received in a said through opening or edge cut-out of said at least one screening media element, interact to prevent mutual rotation therebetween to become induced by rotation of a said pin upon insertion thereof into a said sleeve.

According to a fourth aspect there is provided method for fastening of one or more screening media elements to corresponding attachment sockets of a screening equipment.

In a first embodiment this method comprises: placing a screening media element, having through openings or edge cut-outs with an enlarged and a reduced cross-section portion defining a radially inwardly extending sleeve stop shoulder at a juncture therebetween, upon a screening equipment and aligning said through openings or edge cut-outs with attachment sockets thereof; inserting, into said respective through openings or edge cut-outs of said one or more screening media elements, a respective sleeve comprising an axially extending through opening and a first enlarged cross-section portion and a second reduced cross-section portion defining a radially outwardly extending sleeve stop ledge at a juncture therebetween, such that said sleeve stop ledge rest upon said sleeve stop shoulder and such that at least part of said second reduced cross-section portion protrudes from said at least one screening element and is received in a respective said aligned attachment socket; inserting a respective pin into said axially extending through opening of each respective said sleeve to expand at least said second reduced cross-section portion thereof radially outwardly to become fastened by press fit to said attachment socket and rotating said pin to secure it to said sleeve, whilst preventing mutual rotation between said sleeve and said screening media element during said rotating by using screening media elements and sleeves having complementary shaped rotation prevention form elements at said through openings or edge cut-outs and at said sleeves.

According to a fifth aspect there is provided a screening equipment for separating solid materials according to size.

In a first embodiment this screening equipment comprises: one or more attachment sockets for receiving and holding at least one screening media element having one or more through openings or edge cut-outs each with an enlarged and a reduced cross-section portion defining a radially inwardly extending sleeve stop shoulder at a juncture therebetween, said through openings or edge cut-outs aligned with said attachment sockets; a respective sleeve comprising an axially extending through opening and a first enlarged cross-section portion and a second reduced cross-section portion defining a radially outwardly extending sleeve stop ledge at a juncture therebetween, a respective said sleeve received in a respective of said through openings or edge cut-outs such that a said sleeve stop ledge thereof rest upon said sleeve stop shoulder and such that at least part of said second reduced cross-section portion thereof protrudes from said screening media element and is received in a respective said attachment socket; a respective pin inserted into said axially extending through opening of said sleeve such that at least said second reduced cross-section portion of said sleeve is expanded radially outwardly and fastened by press fit to said respective said attachment socket, wherein said respective pin further is secured to its respective sleeve by securing means requiring rotation of said respective pin, and said one or more through openings or edge cut-outs and said sleeve comprises one or more complementary rotation prevention form elements adapted to interact to prevent mutual rotation therebetween to become induced by rotation of a said pin.

In a further embodiment said screening equipment comprises at least one screening media element, as above, and at least one sleeve and pin combination, as above.

Some of the above embodiments have the beneficial effects of contributing to a decreased risk of accidents and creating better working environments during installation and removal of screening media elements by enabling the use of standard power tools, such as electric screwdrivers or similar, that are safe to operate and by thus eliminating or at least reducing the need to use sledgehammers, screwdrivers, knifes and other similar tools during this work.

Besides health and safety aspects, at least some of the above embodiments could open the possibility to use modular screening media, also in screening machines with very limited free space between screen decks, where tension media is most commonly used today.

### BRIEF DESCRIPTION OF DRAWINGS

In the following, embodiments herein will be described in greater detail by way of example only with reference to attached drawings, in which:

FIG. 1 illustrates schematically a pin and sleeve combination screening media element fastening arrangement.

FIG. 2 illustrates schematically details of the pin and sleeve combination screening media element fastening arrangement according to FIG. 1.

FIG. 3 illustrates schematically an alternative embodiment pin and sleeve combination joinable by a bayonet mount.

FIG. 4 illustrates schematically an alternative embodiment of rotation prevention form elements.

FIG. 5 illustrates schematically an alternative embodiment of rotation prevention form elements.

FIG. 6 illustrates schematically an alternative embodiment of the pin and sleeve combination.

FIG. 7 illustrates schematically a screening equipment for separating solid materials according to size encompassing the pin and sleeve combination screening media element fastening arrangement.

### DETAILED DESCRIPTION OF PREFERRED EMBODIMENT OF THE INVENTION

In the following will be described some example embodiments of an improved sleeve 1 and pin 2 combination for fastening of one or more screening media elements 3 to a corresponding attachment socket 4 of a screening equipment 5.

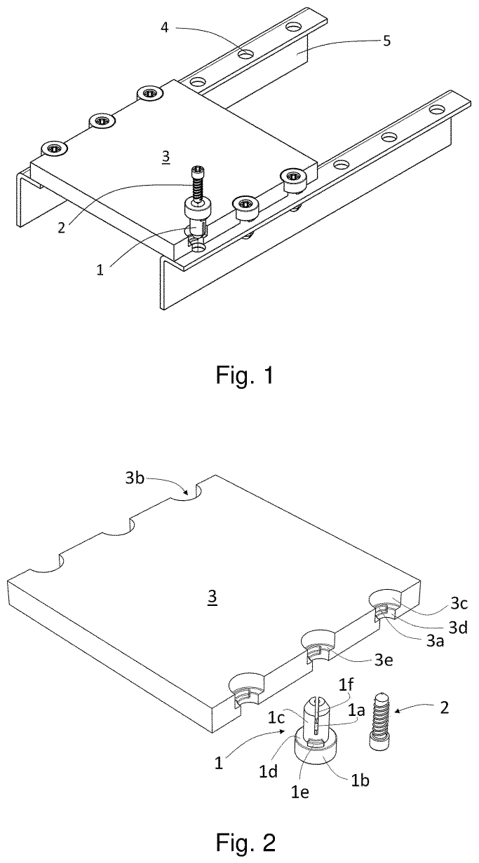

A first embodiment sleeve 1 and pin 2 combination is illustrated in FIG. 1. In this first embodiment, as more clearly evident from FIG. 2, the sleeve 1 comprises an axially extending through opening 1a and a first enlarged cross-section portion 1b and a second reduced cross-section portion. The first enlarged cross-section portion 1b and the second reduced cross-section portion 1c defines a radially outwardly extending sleeve stop ledge 1d at a juncture therebetween. At least part of the second reduced cross-section portion 1c of the sleeve 1 is receivable in a corresponding attachment socket 4 of a screening equipment 5.

The sleeve 1 is suitably made of a polymer material. This polymer material can be polyurethane, thermoplastic polyurethane (TPU) or a similar material. The polymer material can be reinforced, for example with fibres. The sleeve 1 is suitably manufactured by injection moulding.

The pin 2 is adapted to be inserted into the axially extending through opening 1a of the sleeve 1 and rotated to be secured therein. When secured therein the pin 2 will expand at least the second reduced cross-section portion 1c of the sleeve 1 radially outwardly such that it, when received in a corresponding attachment socket 4 of a screening equipment 5, will become fastened by press fit thereto.

The sleeve 1 further comprises one or more rotation prevention form elements 1e. The rotation prevention form elements 1e are adapted to interact with complementary rotation prevention form elements 3a of the one or more screening media elements 3, to prevent mutual rotation between the sleeve 1 and the screening media elements 3 to become induced by rotation of the pin 2 as it is inserted into the axially extending through opening 1a of the sleeve 1 and rotated to be secured therein.

In embodiments of the sleeve 1 and pin 2 combination at least part of the second reduced cross-section portion 1c of the sleeve 1 comprises one or more axial slots 1f, between the axially extending through opening 1a and a periphery thereof. The one or more axial slots 1f are adapted to facilitate radial expansion of the second reduced cross-section portion 1c of the sleeve 1 by the pin 2 as it is inserted into the axially extending through opening 1a of the sleeve 1.

In one alternative embodiment of the sleeve 1 and pin 2 combination the pin 2 is threaded, as illustrated in FIG. 2. The threaded pin 2 is thus adapted to be rotated upon insertion into the axially extending through opening 1a of the sleeve 1 such that it is screwed into the sleeve 1 to become secured therein.

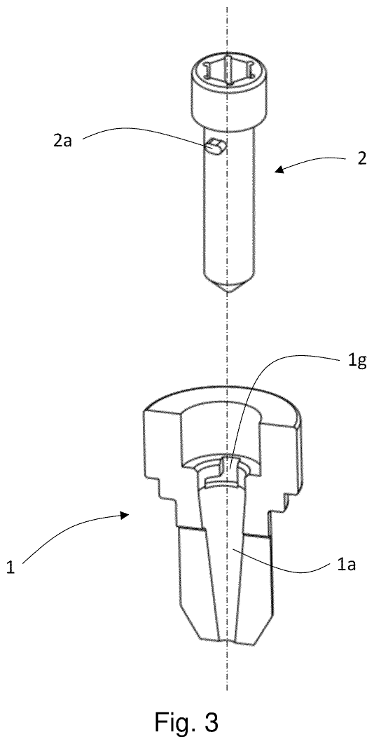

In another alternative embodiment of the sleeve 1 and pin 2 combination, as illustrated in FIG. 3, the pin 2 comprises a first-half 2a of a bayonet mount and the sleeve 1a second-half 1g of a corresponding bayonet mount. This is another way of preventing rotation. The pin 2 is adapted to be rotated upon insertion into the axially extending through opening 1a of the sleeve 1 to become secured therein by interconnection of the bayonet mount halves 2a and 1g resulting from such rotation.

In some embodiments of the sleeve 1 and pin 2 combination the one or more rotation prevention form elements 1e comprises at least one of radially extending cut-outs into or protrusions from a surface of at least one of the first enlarged cross-section portion 1b and the second reduced cross-section portion 1c.

In some further embodiments of the sleeve 1 and pin 2 combination the at least one of cut-outs into or protrusions from a surface of at least one of the first enlarged cross-section portion 1b and the second reduced cross-section portion 1c of the sleeve 1 comprises at least one of: circle-sector shaped; spline shaped; or groove shaped, radially extending cut-outs or protrusions.

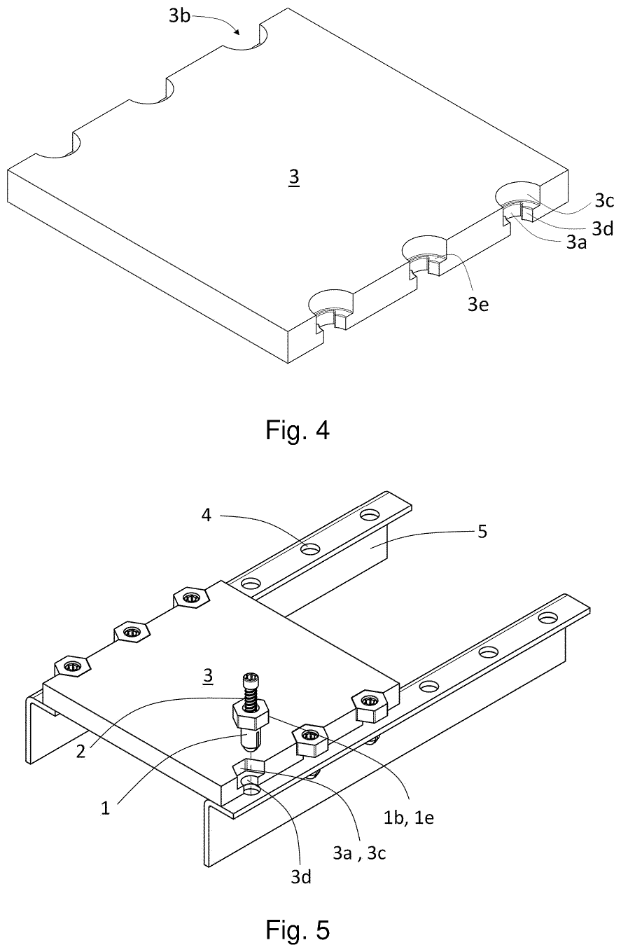

In yet further embodiments of the sleeve 1 and pin 2 combination, as illustrated in FIG. 4, the one or more rotation prevention form elements 1e are provided through the first enlarged cross-section portion 1b of the sleeve 1 having an at least partially non-circular cross-section, here illustrated as hexagonal, adapted to co-operate with an at least partially complementary shaped non-circular cross-section, here also illustrated as hexagonal, enlarged cross-section portion 3c of a through opening or edge cut-out 3b of a screening media element 3.

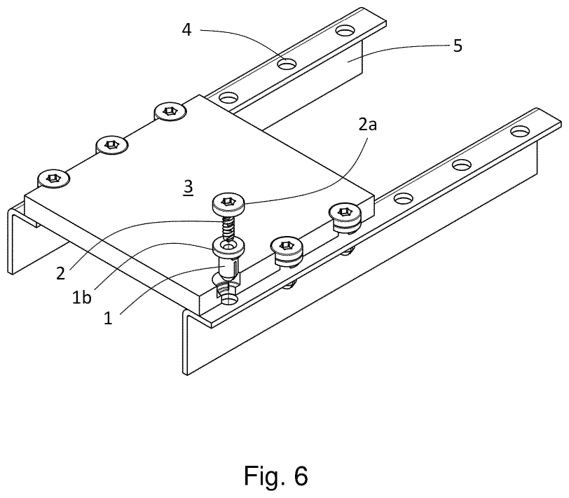

Although the pin 2 is illustrated in FIGS. 1 and 2 as fully insertable into the axially extending through opening 1a of the sleeve 1, in some alternative embodiments, as illustrated in FIG. 6, the first enlarged cross-section portion 1b of a the sleeve 1 is shortened and the pin 2 comprises an enlarged head 2a, which, when mounted, effectively provide an extension of the first enlarged cross-section portion 1b of a the sleeve 1.

The pins 2 may be provided with suitable interfaces for rotation tooling, such as Phillips, hexagonal, Torx, external grooves or similar tooling.

According to a second aspect there is provided a screening media element 3, as illustrated in FIGS. 1 and 2, for co-operation with the above described sleeve 1 and pin 2 combination.

In a first embodiment the screening media element 3 has one or more through openings or edge cut-outs 3b, each with an enlarged 3c and a reduced 3d cross-section portion defining a radially inwardly extending sleeve stop shoulder 3e at a juncture therebetween. The one or more through openings or edge cut-outs 3b are adapted to receive a respective sleeve 1, such that a sleeve stop ledge 1d thereof rest upon the sleeve stop shoulder 3e and such that at least part of a second reduced cross-section portion 1c thereof protrudes from the screening media element 3 such that it is receivable in a corresponding attachment socket 4 of a screening equipment 5. The screening media element 3 comprises one or more rotation prevention form elements 3a adapted to interact with complementary rotation prevention form elements 1e of a sleeve 1 to prevent mutual rotation therebetween to become induced by rotation of a pin 2 upon insertion thereof into a sleeve 1.

The screening media element 3 is suitably made from a polymer material, for example rubber, polyurethane or thermoplastic polyurethane (TPU). It is suitably manufactured by injection molding, compression molding or open cast molding. The screening media element 3 can be reinforced with for example a steel frame, composite frame or similar.

The herein described screening media elements 3, with through openings or edge cut-outs 3b adapted to the rotation-inhibited sleeves 1, are, in at least some embodiments, backwards compatible with traditional sleeves and pins, i.e. sleeves lacking rotation prevention form elements 1e, as described herein.

In some embodiments of the screening media element 3, the one or more rotation prevention form elements 3a comprises at least one of radially extending cut-outs into or protrusions from at least one surface of the enlarged cross-section portion 3c and the reduced cross-section portion 3d of a respective of the one or more through openings or edge cut-outs 3b. In case of cut-outs, backwards compatibility with traditional sleeves is maintained.

In some of these embodiments of the screening media element 3, the at least one of radially extending cut-outs into or protrusions from at least one surface of the enlarged 3c and the reduced 3d cross-section portion of a respective of the one or more through openings or edge cut-outs 3b comprises at least one of: circle-sector shaped; spline shaped; or groove shaped, radially extending cut-outs or protrusions.

The one or more rotation prevention form element 3a cut-outs or protrusions of the screening media element 3 may extend only partially through the screening media element 3, as illustrated in FIGS. 1 and 2, or all the way through the screening media element 3, as illustrated in FIG. 4.

In one alternative embodiment of the screening media element 3, as illustrated in FIG. 5, the one or more rotation prevention form elements 3a are provided through the enlarged cross-section portion 3c of a through opening or edge cut-out 3b of a screening media element 3 at least partially having a non-circular cross-section, here illustrated as hexagonal. The at least partial non-circular cross-section of the enlarged cross-section portion 3c of a through opening or edge cut-out 3b adapted to co-operate with an at least partially complementary shaped non-circular cross-section, here also hexagonal, of a first enlarged cross-section portion 1b of a such sleeve 1. The here illustrated hexagonal configuration is also backwards compatible with traditional sleeves, having a circular cross section.

According to a third aspect there is provided an arrangement 1, 2, 3 for fastening of one or more screening media elements 3 to corresponding attachment sockets 4 of a screening equipment 5.

In a first embodiment, as illustrated in FIG. 1, the arrangement 1, 2, 3 for fastening of one or more screening media elements 3 to corresponding attachment sockets 4 of a screening equipment 5.

The arrangement 1, 2, 3 comprises at least one screening media element 3 that has one or more through openings or edge cut-outs 3b. Each of the through openings or edge cut-outs 3b having an enlarged 3c and a reduced 3d cross-section portion, defining a radially inwardly extending sleeve stop shoulder 3e at a juncture therebetween.

The arrangement 1, 2, 3 further comprises at least one sleeve 1 with an axially extending through opening 1a. The sleeve 1 further comprises a first enlarged cross-section portion 1b and a second reduced cross-section portion 1c, defining a radially outwardly extending sleeve stop ledge 1d at a juncture therebetween.

In the arrangement 1, 2, 3, at least one pin 2 is adapted to be inserted into the axially extending through opening 1a of sleeve 1, to expand at least the second reduced cross-section portion 1c thereof radially outwardly. The one or more through openings or edge cut-outs 3b, of the at least one screening media element 3, are adapted to receive a respective sleeve 1. The screening media element 3, is adapted to receive the sleeve 1 such that a sleeve stop ledge 1d thereof rest upon a sleeve stop shoulder 3e and such that at least part of the second reduced cross-section portion 1c thereof protrudes from the screening media element 3, such that it is receivable in a corresponding attachment socket 4 of a screening equipment 5. Thus, the sleeve 1, when thus received, is adapted to become fastened by press fit to the attachment socket 4 upon a radial outward expansion of at least part of the second reduced cross-section portion 1c caused by insertion of a pin 2.

Each at least one pin 2 of the arrangement 1, 2, 3, is further adapted to be rotated to be secured to a respective sleeve 1, upon insertion into an axially extending through opening 1a thereof.

The one or more through openings or edge cut-outs 3b of the at least one screening media element 3 and the sleeve 1 of the arrangement 1, 2, 3, further comprises one or more complementary rotation prevention form elements 1e, 3a adapted to, when the sleeve 1 is received in a through opening or edge cut-out 3b of the at least one screening media element 3, interact to prevent mutual rotation therebetween to become induced by rotation of a pin 2 upon insertion thereof into a sleeve 1.

According to a fourth aspect there is provided method for fastening of one or more screening media elements 3 to corresponding attachment sockets 4 of a screening equipment 5.

In a first embodiment this method comprises: placing a screening media element 3, having through openings or edge cut-outs 3b with an enlarged 3c and a reduced 3d cross-section portion defining a radially inwardly extending sleeve stop shoulder 3e at a juncture therebetween, upon a screening equipment 5 and aligning the through openings or edge cut-outs 3b with attachment sockets 4 thereof; inserting, into the respective through openings or edge cut-outs 3b of the one or more screening media elements 3, a respective sleeve 1 comprising an axially extending through opening 1a and a first enlarged cross-section portion 1b and a second reduced cross-section portion 1c defining a radially outwardly extending sleeve stop ledge 1d at a juncture therebetween, such that the sleeve stop ledge 1d rest upon the sleeve stop shoulder 3e and such that at least part of the second reduced cross-section portion 1c protrudes from the at least one screening element 3 and is received in a respective aligned attachment socket 4; inserting a respective pin 2 into the axially extending through opening 1a of each respective sleeve 1 to expand at least the second reduced cross-section portion 1c thereof radially outwardly to become fastened by press fit to the attachment socket 4 and rotating the pin 2 to secure it to the sleeve 1, whilst preventing mutual rotation between the sleeve 1 and the screening media element 3 during that rotating by using screening media elements 3 and sleeves 1 having complementary shaped rotation prevention form elements 1e and 3a at the through openings or edge cut-outs 3b and at the sleeves 1.

According to a fifth aspect there is provided a screening equipment 5 for separating solid materials according to size.

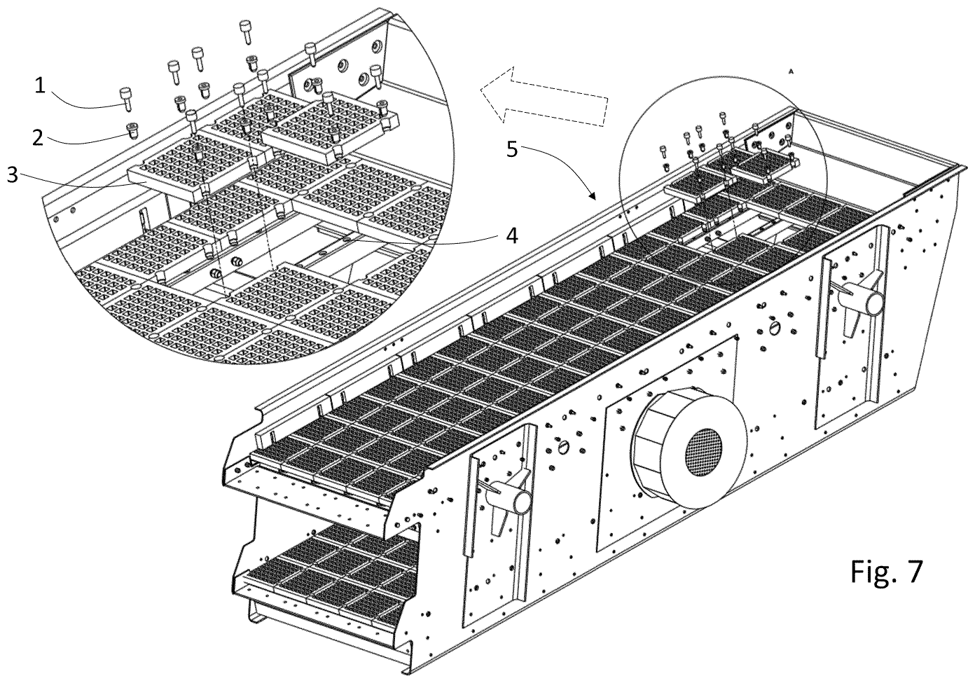

In a first embodiment, as illustrated in FIG. 7, this screening equipment 5 comprises, as shown in more detail in the enlarged view of the circled area as indicated by the dotted arrow, one or more attachment sockets 4 for receiving and holding at least one screening media element 3 having one or more through openings or edge cut-outs 3b each with an enlarged 3c and a reduced 3d cross-section portion defining a radially inwardly extending sleeve stop shoulder 3e at a juncture therebetween. The through openings or edge cut-outs 3b of each screening media element 3 is aligned with the attachment sockets 4.

A respective sleeve 1, comprises an axially extending through opening 1a and a first enlarged cross-section portion 1b and a second reduced cross-section portion 1c, defining a radially outwardly extending sleeve stop ledge 1d at a juncture therebetween. A respective such sleeve 1 is received in a respective of the through openings or edge cut-outs 3b of the screening media elements 3, such that the respective sleeve stop ledges 1d thereof rest upon a respective sleeve stop shoulder 3e and such that at least part of the respective second reduced cross-section portions 1c of the respective sleeves 1 protrudes from the screening media element 3 and is received in a respective attachment socket 4.

A respective pin 2 is inserted into the axially extending through openings 1a of the respective sleeves 1, such that at least the second reduced cross-section portions 1c of the respective sleeves are expanded radially outwardly and fastened by press fit to the respective attachment socket 4.

The respective pins 2 are further secured to their respective sleeves 1 by securing means, such as threads or bayonet mounts, as described in the foregoing, requiring rotation of the respective pin 2.

The one or more through openings or edge cut-outs 3b and the respective sleeves 1 comprises one or more complementary rotation prevention form elements 1e, 3a, adapted to interact to prevent mutual rotation between the sleeves 1 and the one or more through openings or edge cut-outs 3b to become induced by rotation of the pin 2.

In a further embodiment the screening equipment 5 comprises at least one screening media element 3, as above, and at least one sleeve 1 and pin 2 combination, as above.

Thus, some of the above embodiments have the beneficial effects of providing for safe and reliable installation and removal of screening media elements 3 to and from corresponding attachment sockets 4 of an associated screening equipment 5.

Yet some of the above embodiments have the beneficial effects of contributing to a decreased risk of accidents and creating better working environments during installation and removal of screening media elements 3 by enabling the use of standard power tools, such as electric screwdrivers or similar, that are safe to operate and by thus eliminating or at least reducing the need to use sledgehammers, screwdrivers, knifes and other similar tools during this work.

Besides health and safety aspects, at least some of the above embodiments could furthermore open the possibility to use modular screening media 3, also in screening machines with very limited free space between screen decks, where tension media is most commonly used today.

The improved pin and sleeve combination fastening arrangement described herein is not limited for use only with screening media 3, it also be used together with other similar products, such as lining products, for example. Such lining products should suitably be provided with through openings or edge cut-outs 3b comprising one or more rotation prevention form elements 3e adapted to the rotation-inhibited sleeves 1, as described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A sleeve and pin combination for fastening of one or more screening media elements to a corresponding attachment socket of a screening equipment, said sleeve comprising:
an axially extending through opening;
a first enlarged cross-section portion;
a second reduced cross-section portion defining a radially outwardly extending sleeve stop ledge at a juncture therebetween, where at least part of said second reduced cross-section portion of said sleeve is receivable in a corresponding attachment socket , and wherein said pin is arranged to be inserted into said axially extending through opening of said sleeve and rotated to be secured therein to expand at least said second reduced cross-section portion thereof radially outwardly such that it, when received in a corresponding attachment socket of the screening equipment it will become fastened by press fit thereto; and
one or more rotation prevention form elements arranged to interact with complementary rotation prevention form elements of said one or more screening media elements to prevent mutual rotation therebetween to become induced by rotation of said pin.

2. The sleeve and pin combination according to claim 1, wherein at least part of said second reduced cross-section portion of said sleeve includes one or more axial slots between said axially extending through opening and a periphery thereof, said one or more axial slots being arranged to facilitate radial expansion of said second reduced cross-section portion of said sleeve by said pin.

3. The sleeve and pin combination according to claim 1, wherein said pin is threaded and arranged to be rotated upon insertion into said axially extending through opening of said sleeve such that it is screwed into said sleeve to become secured therein.

4. The sleeve and pin combination according to claim 1, wherein said pin includes a first-half of a bayonet mount and said sleeve includes a second-half a corresponding bayonet mount, said pin is being arranged to be rotated upon insertion into said axially extending through opening of said sleeve to become secured therein by interconnection of said bayonet mount halves resulting from said rotation.

5. The sleeve and pin combination according to claim 1, wherein said one or more rotation prevention form elements includes at least one of radially extending cut-outs into or protrusions from a surface of at least one of said first enlarged cross-section portion and said second reduced cross-section portion.

6. The sleeve and pin combination according to claim 5, wherein said at least one of cut-outs into or protrusions from a surface of at least one of said first enlarged cross-section portion and said second reduced cross-section portion of said sleeve includes at least one of: circle-sector shaped; spline shaped; or groove shaped, radially extending cut-outs or protrusions.

7. The sleeve and pin combination according to claim 1, wherein said one or more rotation prevention form elements are provided through said first enlarged cross-section portion of said sleeve having an at least partially non-circular cross-section arranged to co-operate with an at least partially complementary shaped non-circular cross-section enlarged cross-section portion of a through opening or edge cut-out of said screening media element.

8. A screening media element arranged for cooperation with the sleeve and pin combination according to claim 1, said screening media element comprising:
one or more through openings or edge cut-outs each with an enlarged and a reduced cross-section portion defining a radially inwardly extending sleeve stop shoulder at a juncture therebetween, said one or more through openings or edge cut-outs being arranged to receive a respective said sleeve such that a sleeve stop ledge thereof rests upon said sleeve stop shoulder and such that at least part of a second reduced cross-section portion thereof protrudes from said screening media element such that it is receivable in a corresponding attachment socket of the screening equipment; and
one or more rotation prevention form elements arranged to interact with complementary rotation prevention form elements of said sleeve to prevent mutual rotation therebetween to become induced by rotation of said pin upon insertion thereof into said sleeve.

9. The screening media element according to claim 8, wherein said one or more rotation prevention form elements includes at least one of radially extending cut-outs into or protrusions from at least one surface of said enlarged and said reduced cross-section portion of a respective of said one or more through openings or edge cut-outs.

10. The screening media element according to claim 9, wherein said at least one of radially extending cut-outs into or protrusions from at least one surface of said enlarged and said reduced cross-section portion of a respective of said one or more through openings or edge cut-outs includes at least one of: circle-sector shaped; spline shaped; or groove shaped, radially extending cut-outs or protrusions.

11. The screening media element according to claim 8, wherein said one or more rotation prevention form elements are provided through said enlarged cross-section portion of said through opening or edge cut-out at least partially having a non-circular cross-section arranged to co-operate with an at least partially complementary shaped non-circular cross-section of said first enlarged cross-section portion of the sleeve.

12. An arrangement for fastening one or more screening media elements to corresponding attachment sockets of a screening equipment, the arrangement comprising:
at least one screening media element having one or more through openings or edge cut-outs each with an enlarged and a reduced cross-section portion defining a radially inwardly extending sleeve stop shoulder at a juncture therebetween;
at least one sleeve including an axially extending through opening and a first enlarged cross-section portion and a second reduced cross-section portion defining a radially outwardly extending sleeve stop ledge at a juncture therebetween; and
at least one pin arranged to be inserted into said axially extending through opening of said sleeve to expand at least said second reduced cross-section portion thereof radially outwardly, said one or more through openings or edge cut-outs of said at least one screening media element being arranged to receive a respective sleeve such that said sleeve stop ledge thereof rests upon said sleeve stop shoulder and such that at least part of said second reduced cross-section portion thereof protrudes from said screening media element such that it is receivable in a corresponding attachment socket of said screening equipment such that it, when thus received, is arranged to become fastened by press fit thereto upon said radial outward expansion caused by insertion of said pin, wherein each said at least one pin further is arranged to be rotated to be secured to a respective sleeve upon insertion into said axially extending through opening thereof, and said one or more through openings or edge cut-outs of said at least one screening media element and said sleeve includes one or more complementary rotation prevention form elements arranged to, when said sleeve is received in said through opening or edge cut-out of said at least one screening media element, interact to prevent mutual rotation therebetween to become induced by rotation of said pin upon insertion thereof into said sleeve.

13. A method for fastening one or more screening media elements to corresponding attachment sockets of a screening equipment, the method comprising:
placing a screening media element, having through openings or edge cut-outs with an enlarged and a reduced cross-section portion defining a radially inwardly extending sleeve stop shoulder at a juncture therebetween, upon the screening equipment and aligning said through openings or edge cut-outs with attachment sockets thereof;
inserting, into said respective through openings or edge cut-outs of said one or more screening media elements, a respective sleeve having an axially extending through opening and a first enlarged cross-section portion and a second reduced cross-section portion defining a radially outwardly extending sleeve stop ledge at a juncture therebetween, such that said sleeve stop ledge rests upon said sleeve stop shoulder and such that at least part of said second reduced cross-section portion protrudes from said at least one screening element and is received in a respective aligned attachment socket; and
inserting a pin into said axially extending through opening of each sleeve to expand at least said second reduced cross-section portion thereof radially outwardly to become fastened by press fit to said attachment socket and rotating said pin to secure it to said sleeve, whilst preventing mutual rotation between said sleeve and said screening media element during rotation by using screening media elements and sleeves having complementary shaped rotation prevention form elements at said through openings or edge cut-outs and at said sleeves.

14. Screening equipment for separating solid materials according to size comprising:
one or more attachment sockets arranged for receiving and holding at least one screening media element having one or more through openings or edge cut-outs each with an enlarged and a reduced cross-section portion defining a radially inwardly extending sleeve stop shoulder at a juncture therebetween, said through openings or edge cut-outs being aligned with said attachment sockets;
a sleeve having an axially extending through opening, a first enlarged cross-section portion HO and a second reduced cross-section portion defining a radially outwardly extending sleeve stop ledge at a juncture therebetween, said sleeve being received in said through openings or edge cut-outs of the screening media such that said sleeve stop ledge thereof rests upon said sleeve stop shoulder and such that at least part of said second reduced cross-section portion thereof protrudes from said screening media element and is received in a respective said attachment socket;
a pin inserted into said axially extending through opening of said sleeve such that at least said second reduced cross-section portion of said sleeve is expanded radially outwardly and fastened by press fit to said attachment socket, wherein said pin further is secured to a respective sleeve by securing means requiring rotation of the pin, and said one or more through openings or edge cut-outs of the screening media and said sleeve including one or more complementary rotation prevention form elements arranged to interact to prevent mutual rotation therebetween to become induced by rotation of said pin.

15. Screening equipment for separating solid materials according to size comprising:
at least one screening media element; and
at least one sleeve and pin combination according to claim 8.
